(19) United States
(12) Patent Application Publication
(10) Pub. No.: US 2026/0274103 A1
(43) Pub. Date: Sep. 17, 2026

(54) Charging an Electric Vehicle at a Charging Point of a Property

(71) Applicant: Bayerische Motoren Werke Aktiengesellschaft, Muenchen (DE)

(72) Inventors: Jens BERGER, Muenchen (DE); Martin LINGENHEIL, Freising (DE)

(21) Appl. No.: 18/994,656

(22) PCT Filed: Jun. 27, 2023
(86) PCT No.: PCT/EP2023/067357

§ 371 Date: Jan. 15, 2025

(30) Foreign Application Priority Data
Jul. 25, 2022 (DE) 10 2022 118 483.8

(51) Int. Cl. B60L 53/62; B60L 53/51; B60L 53/63; B60L 53/64; B60L 53/66

(52) U.S. Cl. CPC B60L 53/62; B60L 53/51; B60L 53/63; B60L 53/64; B60L 53/66; B60L 2260/58

(57) ABSTRACT

A method for charging an electric vehicle coupled to a charging point of a property is provided. First charging information, including at least an expected departure time and a desired target SoC of the electric vehicle at the departure time, is transmitted to an energy management system assigned to the property with second charging information, which is selected from a maximum number of wake-up events of the electric vehicle, a maximum frequency of wake-up events of the electric vehicle, and a maximum energy throughput between charging point and electric vehicle. A charging plan for the electric vehicle is generated by the energy management system, based on the first charging information, the second charging information, predicted tariff information of an energy supplier relevant to the property, and projected consumption information of the property. The electric vehicle is charged at the charging point according to the charging plan.

### BACKGROUND AND SUMMARY

The invention relates to a method for charging an electric vehicle at a charging point of a property wherein, by the coupling of the electric vehicle to the charging point, charging information, which at least comprises an anticipated departure time and a desired target SoC at the departure time, is transmitted to an energy management system which is assigned to the property, a charging plan for the electric vehicle is generated by the energy management system, at least on the basis of charging information, predicted tariff information of at least one energy supplier which is relevant to the property, and projected consumption information of the property, and the electric vehicle is charged at the charging point according to the charging plan. The invention also relates to a property having at least one charging point for charging an electric vehicle, wherein the property is designed for executing the method. The invention further relates to a system comprising a property and an external data processing system thereto, wherein the system is designed for executing the method. In particular, the invention is advantageously applicable to fully electric-powered electric vehicles.

DE 10 2009 036 816 A1 discloses a method and a device for controlling charging stations for electric vehicles. For the minimization of peak power demands, at least two charging stations are combined in a group, actual charging parameters are exchanged between charging stations within the group, a charging forecast is established for the group, at least in accordance with the actual charging parameters, and target charging parameters are defined for charging stations in the group, in accordance with the charging forecast.

DE 10 2013 010 774 A1 discloses a method for operating a charging station for electric vehicles, wherein a maximum rated value for a charging current or a charging power is determined, the maximum rated value for the charging current or charging power thus determined is transmitted to an electric vehicle which is electrically coupled to the charging station, a first time interval is at least determined in accordance with the maximum rated value and, during the first time interval, the electric vehicle is charged with charging current at the maximum rated value. In order to increase the service life of the charging station, a reduced rated value for the charging current and a second time interval are specified, wherein the second time interval defines a period during which the charging current or charging power is not permitted to exceed the reduced rated value, the reduced rated value is transmitted to the electric vehicle and, during the second time interval, the electric vehicle is charged, to a maximum, at the reduced rated value of the charging current or charging power.

DE 10 2018 202 755 A1 discloses a method for adapting a supply of electric power to an electric power demand in an electric grid system, in which at least one electric charging station is operated wherein, according to the method, by means of a grid system control device, a charging forecast is established for at least one motor vehicle, which indicates the future charging period in which the electric vehicle is expected to exchange electrical energy with the grid system, a temporal characteristic for existing power demand on the grid system is estimated in accordance with the respective charging forecast, a temporal characteristic of available power on the grid system is determined and, for at least one such charging period, in which it is detected that the available power is lower than the estimated power demand, at least one predetermined compensating measure is triggered wherein, by means of the at least one compensating measure, available power is matched to power demand.

US 2017/0136894 A1 discloses methods, devices and systems for communicative exchange between a vehicle and a charging system. The communicative exchange can comprise charging demand messages which are transmitted by, or received from the vehicle, and which define charging details such as, for example, a type of charging, charging locations, direction of charging and/or further information which corresponds to charging requirements for the vehicle which posts a demand. The charging system can respond to charging demand messages, wherein it accepts or rejects the demand for vehicle charging. In response to the acceptance of the demand message, the charging system enables a charging of the vehicle, in accordance with the charging details.

US 2017/0140603 A1 discloses a system for vehicle fleet administration, comprising: a basic administration system which is configured to enable one or more fleet vehicles to receive a vehicle service, wherein the basic administration system comprises a database, a communication module and an analysis module, wherein the communication module communicates with the single or multiple fleet vehicles, the analysis module and the database; one or more fleet vehicles, wherein each fleet vehicle comprises a vehicle database and is respectively configured to receive a charging service and to communicate a vehicle state-of-charge to the communication module, at least one fleet service location, which is configured such that it transmits a billing price to the communication module, and executes the billing service at the billing price; wherein the analysis module receives the charging price and specifies whether the at least one fleet service location has been selected to deliver the charging service for at least one fleet vehicle which is operating with an insufficient state-of-charge; wherein a charging service is delivered by the at least one fleet service location to the at least one fleet vehicle which is operating with an insufficient state-of-charge, in the event that the analysis module selects the at least one fleet service location.

The object of the present invention is to at least partially surmount the disadvantages of the prior art and to provide an improved facility for charging an electric vehicle at a charging point of a property.

This object is fulfilled by the features of the independent claims. Preferred embodiments can be inferred from the dependent claims.

This object is fulfilled by a method for charging an electric vehicle at a charging point of a property wherein, by the coupling of the electric vehicle to the charging point:
first charging information, which at least comprises an anticipated (desired or probable) departure time, a present state-of-charge (“actual SoC”) of the drive battery, a desired state-of-charge (“target SoC”) of the drive battery at the departure time and/or a desired quantity of energy at the departure time, together with, optionally, a capacity of the drive battery, is transmitted to an energy management system which is assigned to the property;
second charging information is transmitted to the energy management system;
a charging plan for the electric vehicle is generated by means of the energy management system, at least based on the first charging information, the second charging information, predicted tariff information of at least one energy supplier which is relevant to the property, and projected consumption information of the property; and
the electric vehicle is charged at the charging point, in accordance with the charging plan;
wherein the second charging information comprises at least one charging parameter from the group consisting of: at least a maximum number of wake-up events of the electric vehicle, a maximum frequency of wake-up events of the electric vehicle, at least one maximum charging activity time of the electric vehicle, and a maximum energy throughput between the charging point and the electric vehicle.

This method provides an advantage, in that the energy management system, by the consideration of the second charging information, can constitute a charging plan for the electric vehicle, wherein the electric vehicle is more substantially protected and is charged in a more energy-saving manner than previously. The restriction of the number of wake-up events thus enables a reduced loading of vehicle electronics associated with the run-up thereof, e.g., from an idling or standby state. Additionally, an energy consumption of vehicle electronics can thus be maintained within limits. Restriction of the energy throughput advantageously protects the drive battery of the electric vehicle.

An energy throughput can be understood as the electrical energy, electric power or quantity of current which, regardless of the direction of current flow, is exchanged between the charging point and the electric vehicle.

The electric vehicle typically comprises a drive battery for driving the electric vehicle. The electric vehicle can be, for example, a hybrid vehicle—a PHEV, or a fully electrically powered vehicle—a BEV. The electric vehicle can be charged by means of a charging cable and/or inductively. The charging point can be a charging station, e.g., a wall box, or a charging zone for inductive charging. Connection of the electric vehicle to a charging point can thus include the connection or coupling thereof to a charging point by means of a charging cable, or inductively.

In a wake-up event, vehicle electronics are “run up” or “woken up” from an idling, sleeping or standby state, as a result of which they consume more energy than in an idling state, etc. and moreover, for example, are also mechanically and thermally loaded. A wake-up event thus comprises a wake-up of vehicle electronics, or of an element thereof.

According to a further development, the charging point and the electric vehicle are designed for charging and discharging the drive battery of the electric vehicle, which can also be described as “bidirectional charging”. Correspondingly, the charging plan can then provide for the phased charging and discharging of the drive battery, as required. In particular, the drive battery of the electric vehicle, during the connection period of the electric vehicle to the charging point, can thus be employed as an electricity buffer storage facility, e.g., within the meaning of “V2H” (“Vehicle-to-Home”) and/or “V2G” (“Vehicle-to-Grid”) concepts. This can include the incorporation in the charging plan of “dead times”, during which the drive battery is neither charged nor discharged.

In particular, the property comprises an electric power or energy grid (also described hereinafter, without limitation of generality, as a “household energy grid”), which is connected via a grid connection point having an intelligent electricity meter (a “smart meter”, having additional instrument functions), to the public energy supply grid. Tariff information can comprise, for example, present and predicted electricity supply costs for the extraction of electrical energy from the energy supply grid and, optionally, a present and predicted power infeed remuneration for an infeed of electrical energy from the household energy grid to the energy supply grid.

An energy supplier which is relevant to the property can be understood as an energy supplier from which electrical energy can be obtained via the grid connection point and to which, optionally, electrical energy can be delivered via the grid connection point, in the event of a surplus on the household energy grid. According to a further development, a property can be contractually associated with a specific energy supplier or, alternatively, can be contractually associated with a specific grid system operator.

However, the generation of the charging plan is not limited to a consideration of the above-mentioned information. Thus, according to a further development, costs and/or prices can also be considered which do not proceed directly from a contractual relationship, for example production costs for self-generated electricity, non-monetary prices or cost functions associated with an optimization such as, e.g., a “CO2” price of energy, etc.

The at least one charging point, and typical electrical loads such as cookers, laundry appliances, lamps, media devices, boilers, air-conditioning systems, etc., can be connected to the household energy grid. Projected consumption information for the property can comprise a typical (e.g., daytime and/or weekday) profile of the electrical consumption of loads. Projected consumption information can be retrieved from historical data for the energy consumption of the property.

The energy management system (also described hereinafter, without limitation of generality, as a “household energy management system”, or “HEMS”), is particularly employed for forecasting an extraction of energy and, optionally, of any surplus on the household energy grid, and—where the electric vehicle is connected, in consideration of the drive battery—to execute an optimization thereof such that at least one predefined objective is fulfilled in a particularly effective manner, e.g., reduced extraction costs from the energy supply grid, environment-friendly electricity generation, etc. Optimization can be executed where an electric vehicle is connected to the charging point, and thus to the household energy grid, by way of a single buffer storage facility, specifically for a prolonged period. For example, the drive battery can then be charged during periods when electrical energy can be particularly cost-effectively obtained from the public energy supply grid, and discharged, e.g., in order to reduce an extraction of energy for the household energy grid from the public energy supply grid, during periods of higher electricity prices and/or to inject a surplus from the household energy grid into the public energy supply grid, during periods when the associated remuneration is high.

However, it is possible for the energy management system not to control the charging and discharging of the drive battery of the electric vehicle in an entirely unrestricted and ad hoc manner, according to the requirements of the household energy grid, but instead to generate a charging plan (i.e., a planned profile of a charging or discharge current between the charging point and the electric vehicle during a connection period of the electric vehicle) which also considers the first and second charging information with respect to the electric vehicle.

The association of the energy management system with the property can include the constitution of the energy management system as part of the property, e.g., the implementation thereof in a computer of the property. Alternatively or additionally, the energy management system can be an external system which is coupled, for the purposes of data communication, to the household energy grid or to electrical devices thereof (e.g. to the charging point, to at least one electricity meter, etc.). The energy management system can be implemented on a network computer or can be cloud-based.

According to a further development, the first charging information can comprise the present state of charge (“SoC”) and the desired state-of-charge (“target SoC”) of the drive battery at the departure time, particularly in combination with a capacity of the drive battery. This is advantageous, for example, if the SoC is communicated from the electric vehicle to the charging point, e.g., according to ISO 15118-2.

Additionally or alternatively, the first charging information can comprise a desired quantity of energy of the electric vehicle at the departure time. This is advantageous, in the event that the SoC is not communicated from the electric vehicle to the charging point, as can optionally be provided, for example according to ISO 15118-2.

Optionally, the first charging information also comprises a capacity of the drive battery of the electric vehicle, a state-of-charge which is not to be undershot (“minimum SoC”) and/or a maximum and/or minimum charging and/or discharging power.

In particular, the term “maximum charging activity time” describes that duration of time, in particular prior to the departure time, during which the drive battery can be charged and/or discharged, and is not, e.g., in an idling or standby state. The “at least one” maximum charging activity time can be an absolutely stipulated charging activity time (duration), e.g., a maximum of 3 hours, and/or a percentage figure (e.g. a maximum 20%) of the connection time, or similar.

According to one configuration, the at least a maximum number of wake-up events of the electric vehicle is or comprises a maximum number of all wake-up events, or a maximum number of wake-up events of all types, or for any purpose. Thus, the restriction of overall loading associated with wake-up events is advantageously enabled.

According to one configuration, the at least a maximum number of wake-up events of the electric vehicle is or comprises a maximum number of wake-up events associated with the renegotiation of charging plans. By the renegotiation of charging plans, for example, it can be understood that a new charging plan has been generated (e.g., on the grounds that specified projections, such as electricity tariffs, have altered since the generation of the previous charging plan), and that this charging plan is attuned to the electric vehicle, or negotiated, in order to replace the previous charging plan. For this renegotiation, it is necessary for vehicle electronics to be run-up or woken up from an idling or standby state.

According to one configuration, the at least a maximum number of wake-up events of the electric vehicle is or comprises a maximum number of wake-up events associated with charging processes during an execution of a charging plan. As a result, advantageously, the number of wake-up events during the execution of a charging plan is self-limiting. Consideration is provided to the effect that the charging plan, particularly in the event of a prolonged connection time, can include charging dead times, during which no charging (i.e., charging and discharging) is to be executed. During these charging dead times, vehicle electronics typically assume an idling or standby state. By means of this configuration, it is prevented that an excessively frequent changeover between charging and non-charging phases occurs.

According to one configuration, the maximum number of wake-up events prior to the departure time of the electric vehicle is stipulated, e.g., a maximum of five wake-up events prior to the departure time. Alternatively or additionally, the maximum number of wake-up events can be stipulated for a given period of time, per 8 hours, per 12 hours or per 24 hours.

According to a further development, the maximum number of wake-up events can lie between four and ten, i.e., between five and seven and, in particular, is equal to five.

According to one configuration, the maximum frequency of wake-up events is stipulated in units per hour. According to a further development, the maximum frequency is one wake-up event per hour, or less, e.g., one wake-up event every two hours.

According to one configuration, at least one of the charging parameters associated with the second charging information is dependent upon a state-of-health of a drive battery (also described as “SoH”) of the electric vehicle, an age of vehicle electronics, an—in particular also a predicted—exterior temperature, and/or is dependent upon a user behavior of a user of the electric vehicle. For example, the potential variation of such a charging parameter by reference to the SoH supports the further protection of vehicle components which are loaded during charging, in particular the drive battery itself. Thus, for example, if a SoH of the drive battery is comparatively poor (e.g., on the grounds of its age, wear associated with a large number of rapid charging processes, etc.), the maximum energy throughput can be reduced. Moreover, the maximum energy throughput can be reduced in the event that, during the connection time, colder exterior temperatures are anticipated. Additionally, a maximum number of wake-up events can be reduced, in the case of older electronics.

According to one configuration, the second charging information is saved in a data memory of the electric vehicle, and is transmitted from a data memory of the electric vehicle to the energy management system. This enables a particularly simple delivery and transmission thereof to the energy management system. For example, the second charging information (as per the first charging information) can be transmitted to the charging point, which relays the charging information to the energy management system. According to a further development, the electric vehicle and the charging point are configured to exchange data in compliance with ISO 15118-2 and/or with ISO 15118-20. Alternatively or additionally, the electric vehicle can transmit charging information directly to the energy management system, e.g. via a wireless interface (e.g., LTE or WLAN).

According to one configuration, second charging information is transmitted from an external data processing device to the energy management system. This provides an advantage, in that it is not necessary for second charging information to be stored in the electric vehicle, and moreover permits the updating thereof in a particularly simple manner. This configuration can be implemented such that, for example, by means of (i.e., shortly before, during or after) the coupling of the electric vehicle to the charging point, information including, e.g., a vehicle ID (EV-ID) and a charging point ID (EVSE-ID) is transmitted to the external data processing device, by the electric vehicle, the charging point or the energy management system, and second charging information associated with the EV-ID is then transmitted to the charging point having this EVSE-ID.

According to one configuration, the external data processing device is a data processing device which is supported by a manufacturer of the electric vehicle. This is particularly advantageous on the grounds that detailed information with respect to the state of the vehicle, e.g., the SoH thereof, software status, service history, etc., is present in the external data processing device, and this information can be employed, in a particularly effective manner, for the targeted adaptation of second charging information to the electric vehicle which is to be charged.

According to one configuration, the property is equipped with at least one electricity generating facility, particularly a photovoltaic installation, a wind power installation and/or a geothermal installation, and the charging plan for the electric vehicle provided by means of the energy management system is additionally generated on the basis of an electricity generating forecast for the electricity generating facility. This at least one electricity generating facility is employed for injecting electrical energy into the household energy grid and can be part of the household energy grid, or is connected to the household energy grid. Consumption information for the property, in addition to the projected energy consumption of electrical loads which are connected to the household energy grid, can then include a forecast of electrical energy which is injected into the household energy grid by the at least one electricity generating facility. This configuration provides an advantage, in that the optimization or management of the energy flux through the grid connection point, and thus additionally the charging plan, can be executed in a particularly effective and flexible manner. Potential forecasts or forecast data can typically comprise, for example, electricity prices for the injection of any surplus into the public energy supply grid which are dependent upon the time of day, weather forecasts, etc.

According to one configuration, the property is equipped with at least one stationary electricity buffer storage facility, or at least one stationary electrical energy store for the buffer storage of electrical energy is connected to the household energy grid of the property, and the charging plan for the electric vehicle provided by means of the energy management system is additionally generated on the basis of a storage capacity of the buffer store. This advantageously enables a particularly flexible set-up of a charging plan.

The object is also fulfilled by a property having at least one charging point for charging an electric vehicle, wherein the property is configured for executing the above-mentioned method. The property can be configured in an analogous manner to the method, and vice versa, and comprises the same advantages.

According to a further development, the property is equipped with at least one electricity generating facility and/or with at least one stationary electricity buffer storage facility.

According to a further development, an energy management system is assigned to the property which is designed to generate a charging plan for the electric vehicle, at least based on the first charging information, the second charging information, predicted tariff information of at least one energy supplier which is relevant to the property, and projected consumption information of the property.

According to one configuration, the property is a single-family residence or a multi-family residence.

This object is also fulfilled by a system comprising an above-mentioned property and a data processing device which is external thereto, wherein the system is designed for executing the method by the employment of the external data processing device, as described above. The system can be configured in an analogous manner to the property and the method, and vice versa, and comprises the same advantages.

The above-mentioned properties, features and advantages of the present invention, and the manner in which these are achieved, are further explained and clarified in conjunction with the following schematic description of one exemplary embodiment, which is described in greater detail with reference to the drawings.

### BRIEF DESCRIPTION OF THE DRAWINGS

FIG. 1 shows a system having a property and an external data processing device which is coupled thereto, wherein an electric vehicle is connected to a charging point of the property for charging; and

FIG. 2 shows a potential sequence of a method for charging the electric vehicle at the charging point of the property according to FIG. 1.

### DETAILED DESCRIPTION OF THE DRAWINGS

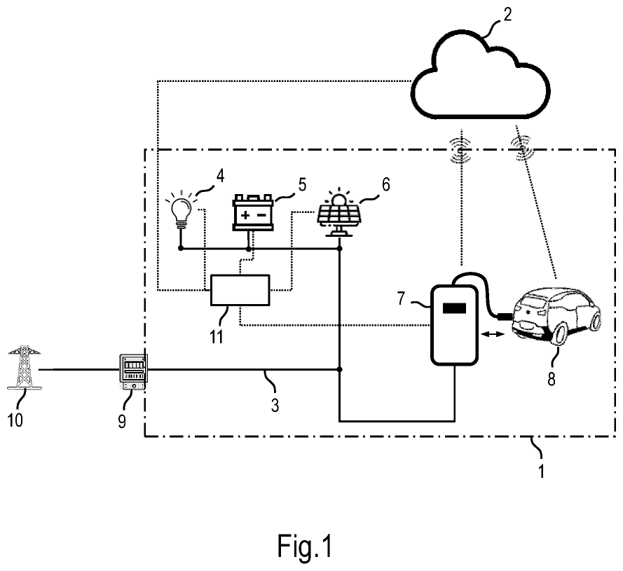

FIG. 1 shows a system having a property in the form of a single-family residence 1 and an external data processing device 2 which is coupled thereto. The single-family residence 1 comprises a household energy grid 3 for supplying electrical loads 4 with electric current. A stationary electrical energy buffer store 5, a photovoltaic installation 6 and a charging point in the form of a wall box 7 for charging the electric vehicle 8 are additionally integrated in the household energy grid 3. According to a further development, the stationary buffer store 5 can be integrated in the photovoltaic installation 6. In the present case, the household energy grid 3 is exemplarily connected to a public power grid or energy supply grid 10 via a metering point or a grid connection point in the form of a “smart meter” 9.

If the electric vehicle 8 is connected to the wall box 7, it can be employed, in consideration of the first and second charging information, as a buffer store for the household energy grid 3, and correspondingly charged and discharged. The wall box 7 and the electric vehicle 8 can exchange data, e.g., in accordance with ISO 15118-20. In particular, the wall box 7 can receive, from the electric vehicle 3, charging parameters included in a first charging information, such as a capacity of the drive battery, a present actual SoC, a desired or anticipated departure time, a target SoC at the departure time and, optionally, a maximum charging power, a minimum SoC to be observed, etc.

The household energy grid 3 also comprises a household energy management system or HEMS 11, which is employed for controlling a charging and discharging process of the buffer store 7 and, in the event of the connection thereof, of the drive battery of the electric vehicle 8 which functions as a buffer store. The HEMS 11 is connected, for the purposes of data communication, to the photovoltaic installation 6, the stationary buffer store 5, the wall box 7 and, optionally, to at least one of the loads 4, as indicated by the broken lines. In the event that, as exemplarily assumed in the present case, the grid connection point is a “smart meter” 9, the HEMS 11 can also be connected thereto for the purposes of data communication. In principle, however, other data communication topologies can also be implemented: e.g., the smart meter 9 can thus be connected to the wall box 7 for the purposes of data communication.

According to a further development, the HEMS 11 can receive charging parameters according to the first and second charging information via the wall box 7. According to another further development, the HEMS 11 can at least receive charging parameters according to the second charging information from the external data processing device 2, which is connected to the HEMS 11, the wall box 7 and/or the electric vehicle 8 for the purposes of data communication and which, upon the coupling of the electric vehicle 8, initiates the transmission of charging parameters according to the second charging information to the HEMS 11. For example, by the coupling of the electric vehicle 8 to the wall box 7, by means of the electric vehicle 8, the wall box 7 or the HEMS 11, information such as an EV-ID and an EVSE-ID can be transmitted to the external data processing device 2, which then transmits second charging information associated with the EV-ID to the HEMS 11, for example, directly or via the wall box 7.

The external data processing device 2 can be, for example, a data processing device or IT system which is supported or operated by a manufacturer of the electric vehicle 8. The external data processing device 2 can comprise, e.g., at least one network server and/or can be cloud-based. The external data processing device 2, for example, can be directly connected to the wall box 7, to the electric vehicle 8 and/or to a user terminal device 14, e.g., to a portable user terminal device such as a smartphone or tablet PC of a user of the electric vehicle 8, for the purposes of data communication, e.g., in a hard-wired and/or wireless arrangement.

The HEMS 11, at least based on the first and second charging information, a forecast of electricity consumption in the household energy grid 3, a forecast of electricity generation by the photovoltaic installation 6 (e.g., employing historical data and/or weather forecasts) and projected tariff information with respect to extraction from, and injection into the energy supply grid 10, generates a charging plan (comprising charging and discharging) for the electric vehicle 8 up to the anticipated departure time, in order to influence the current flux through the smart meter 9 for the optimization of at least one specified purpose, e.g., for the optimization of costs. The charging plan for the electric vehicle 8 generated by the HEMS 11 (also described hereinafter as the “HEMS charging plan”) also considers charging parameters which are communicated by the electric vehicle 8, by way of marginal charging conditions. The charging plan for the electric vehicle 8 can be transmitted by the HEMS 11 to the wall box 7, which then executes this charging plan, in combination with the electric vehicle 8.

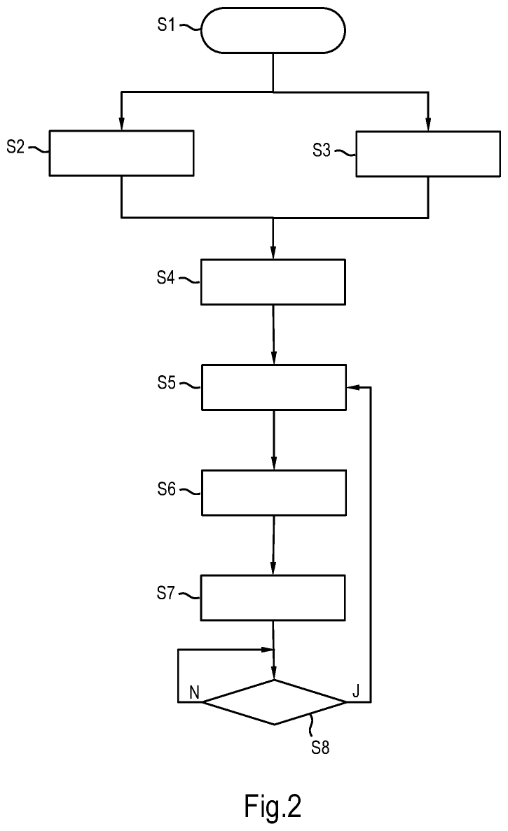

FIG. 2 shows a potential sequence of a method for charging the electric vehicle 8 at the wall box 7 of the single-family residence 1.

In a first step S1, the electric vehicle 8 is connected to the wall box 7, e.g., by means of a charging cable.

In a second step S2, charging parameters associated with the first charging information, such as an actual SoC, a target SoC, an anticipated departure time, a minimum SoC, etc., are transmitted by the electric vehicle 8 to the wall box 7.

In a third step S3, charging parameters associated with the second charging information, such as at least one maximum number of wake-up events of the electric vehicle 8, a maximum frequency of wake-up events of the electric vehicle 8, at least a maximum charging activity time of the electric vehicle 8 and/or a maximum energy throughput between the wall box 7 and the electric vehicle 8, are transmitted to the wall box 7, e.g., by the electric vehicle 8 or—further to notification with respect to the connection—by the external data processing device 2.

In a fourth step S4, charging parameters associated with the first and second charging information are transmitted by the wall box 7 to the HEMS 11.

Alternatively, a number of charging parameters which are associated with the first charging information, such as a target SoC, the anticipated departure time, etc., can also be transmitted by the user terminal device 14 to the wall box 7 or to the HEMS 11. For example, a user can input the anticipated departure time and/or the desired target SoC at that time using an application program which is executed on a smartphone.

In a fifth step S5, the HEMS 11 generates a charging plan for the electric vehicle 8, which considers charging parameters associated with the first and second charging information.

In a sixth step S6, the charging plan is transmitted to the wall box 7 which then, in a step S7, employs this charging plan, by interaction with the electric vehicle 8, for charging the electric vehicle 8. To this end, for example, the actual SoC is communicated at short time intervals by the electric vehicle 8 to the wall box 7. Alternatively, the charging plan is only saved in the HEMS 11 (and not in the wall box 7) wherein, for example, at short time intervals, a (positive/negative) target charging power/current is communicated to the wall box 7, and the wall box 7 and the electric vehicle 8 execute an adjustment thereto.

Moreover, in a step S8, a check is executed for any change in the influencing variables which are fundamental to the generation of the charging plan, e.g., the projected tariff information, a weather forecast, etc. If this is the case (“J”), a bifurcation is executed to step S5 and, if possible, a new charging plan is generated by the HEMS 11, which is also required to consider charging parameters (including a present actual SoC) which are associated with the first and second charging information. In step S6, the new charging plan is then transmitted to the wall box 7 which, in step S7, then employs the new charging plan, by interaction with the electric vehicle 8, for charging the electric vehicle 8. However, if this is not the case (“N”), step S8 is repeated.

According to a further development, charging can be terminated, once the charging plan has been executed.

Naturally, the present invention is not limited to the exemplary embodiment disclosed.

In general, “a”, “an”, etc. can be understood as a singularity or a plurality, particularly within the meaning of “at least one” or “one or more”, etc., provided that this is not explicitly excluded, e.g. by the expression “exactly one”, etc.

An indication of number can also comprise exactly the number indicated, or can also comprise a customary tolerance margin, provided that this is not explicitly excluded.

### List of Reference Symbols

1 Single-family residence
2 External data processing device
3 Household energy grid
4 Electrical load
5 Stationary electrical energy buffer store
6 Photovoltaic installation
7 Wall box
8 Electric vehicle
9 Smart meter
10 Energy supply grid
11 Household energy management system
S1-S8 Process steps

1.-13. (canceled)

14. A method for charging an electric vehicle at a charging point of a property, the method comprising:
coupling the electric vehicle to the charging point;
transmitting first charging information, including an anticipated departure time, an actual state of charge of the drive battery, a desired target state of charge of the electric vehicle at the departure time and/or a desired quantity of energy at the departure time, to an energy management system which is assigned to the property;
transmitting second charging information to the energy management system;
generating, by the energy management system, a charging plan for the electric vehicle based on the first charging information, the second charging information, predicted tariff information of at least one energy supplier which is relevant to the property, and projected consumption information of the property; and
charging the electric vehicle at the charging point in accordance with the charging plan;
wherein the second charging information includes at least one charging parameter from the group consisting of:
a maximum number of wake-up events of the electric vehicle,
a maximum frequency of wake-up events of the electric vehicle,
a maximum charging activity time of the electric vehicle, and
a maximum energy throughput between the charging point and the electric vehicle.

15. The method according to claim 14, wherein the maximum number of wake-up events of the electric vehicle comprises a number from the group consisting of:
a maximum number of all wake-up events,
a maximum number of wake-up events associated with renegotiations of charging plans, and
a maximum number of wake-up events associated with charging processes during an execution of the charging plan.

16. The method according to claim 15, wherein the maximum number of wake-up events of the electric vehicle is stipulated up to the departure time of the electric vehicle and/or per unit of time.

17. The method according to claim 16, wherein the unit of time is a day.

18. The method according to claim 14, wherein the maximum frequency of wake-up events of the electric vehicle is stipulated in units per hour or less.

19. The method according to claim 16, wherein the maximum frequency of wake-up events of the electric vehicle is stipulated in units per hour or less.

20. The method according to claim 14, wherein at least one of the charging parameters associated with the second charging information is dependent upon at least one of a state-of-health of a drive battery of the electric vehicle, an age of vehicle electronics, an exterior temperature, and a user behavior of a user of the electric vehicle.

21. The method according to claim 15, wherein at least one of the charging parameters associated with the second charging information is dependent upon at least one of a state-of-health of a drive battery of the electric vehicle, an age of vehicle electronics, an exterior temperature, and a user behavior of a user of the electric vehicle.

22. The method according to claim 14, wherein the second charging information is saved in a data memory of the electric vehicle and is transmitted from the data memory of the electric vehicle to the energy management system.

23. The method according to claim 15, wherein the second charging information is saved in a data memory of the electric vehicle and is transmitted from the data memory of the electric vehicle to the energy management system.

24. The method according to claim 14, wherein the second charging information is transmitted from an external data processing device to the energy management system.

25. The method according to claim 15, wherein the second charging information is transmitted from an external data processing device to the energy management system.

26. The method according to claim 24, wherein the external data processing device is configured to be supported by a manufacturer of the electric vehicle.

27. The method according to claim 25, wherein the external data processing device is configured to be supported by a manufacturer of the electric vehicle.

28. The method according to claim 14, wherein the property is equipped with an electricity generating facility including a photovoltaic installation, and the charging plan for the electric vehicle is additionally generated based on an electricity generating forecast for the electricity generating facility.

29. The method according to claim 15, wherein the property is equipped with an electricity generating facility including a photovoltaic installation, and the charging plan for the electric vehicle is additionally generated based on an electricity generating forecast for the electricity generating facility.

30. The method according to claim 14, wherein the property is equipped with a stationary electrical energy buffer store, and the charging plan for the electric vehicle is additionally generated based on a storage capacity of the buffer store.

31. A property including a charging point for charging an electric vehicle, wherein the property configured to execute a method according to claim 14.

32. The property according to claim 31, wherein the property is a single-family residence or a multi-family residence.

33. A system comprising:
a property including a charging point configured to charge an electric vehicle that is coupled to the charging point; and
a data processing system which is external to the property;
wherein the data processing system is configured to:
transmit first charging information, including at least one of an anticipated departure time, an actual state of charge of the drive battery, a desired target state of charge of the electric vehicle at the departure time and a desired quantity of energy at the departure time, to an energy management system which is assigned to the property;
transmit second charging information to the energy management system;
generate, by the energy management system, a charging plan for the electric vehicle based on the first charging information, the second charging information, predicted tariff information of at least one energy supplier which is relevant to the property, and projected consumption information of the property; and
charge the electric vehicle at the charging point in accordance with the charging plan;
wherein the second charging information includes at least one charging parameter from the group consisting of:
a maximum number of wake-up events of the electric vehicle,
a maximum frequency of wake-up events of the electric vehicle,
a maximum charging activity time of the electric vehicle, and
a maximum energy throughput between the charging point and the electric vehicle.
